(19) United States
(12) Patent Application Publication
(10) Pub. No.: US 2007/0071943 A1
(43) Pub. Date: Mar. 29, 2007

(54) Cut Sheets For Use In Printer Apparatus

(75) Inventors: Hiroyuki Okuchi, Nagoya-shi, Aichi-ken (JP); Yasunori Nakamura, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi, Aichi-ken (JP)

(21) Appl. No.: 11/536,560

(22) Filed: Sep. 28, 2006

(30) Foreign Application Priority Data
Sep. 29, 2005 (JP) 2005284813

(51) Int. Cl. B32B 3/04

(52) U.S. Cl. 428/121

(57) ABSTRACT

A sheet of paper is formed by a first cut sheet of paper and a second cut sheet of paper. The sheet of paper includes a first pasting portion provided across the entire width of the front end of each of the first sheet of paper and the second sheet of paper, second pasting portions at which the first sheet of paper and the second sheet of paper are adhered to each other by a plurality of dots of adhesive at two sides on the rear end side with respect to the first pasting portion, and third pasting portions at which the first of paper and the second sheet of paper are adhered to each other by a plurality of dots of adhesive at two sides on the rear end side with respect to the second pasting portions. The first pasting portion is bonded with an adhesive agent that does not readily release, while the second pasting portions and the third pasting portions are bonded by means of an adhesive agent that may release, so that they may be separated after printing. The first sheet of paper, which is of a heat sensitive type, includes on its upper surface a coloring layer that colors when heated or a punch layer in which holes form when heated.

### BACKGROUND OF THE INVENTION

1. Field of the Invention

The present invention relates to cut sheets for use in printer apparatus and, more specifically, printer apparatus cut sheets having a size greater than that of a paper cassette.

2. Description of Related Art

A known printer apparatus is described in Japanese Patent Application Laid Open Publication No. 2003-170640, wherein by mounting a paper cassette in which printing paper (e.g., cut sheets) for printing is set, information is printed on the printing paper as it is dispatched from the paper cassette. Further, with respect to printing paper used in such a printer apparatus, for example, a cut sheet, as described in Japanese Patent Application Laid Open Publication No. 2003-285550, includes two sheets of paper: an heat sensitive sheet of a paper and copying sheet of paper, which are bonded to each other through pasting. This cut sheet is configured, such that two sheets of paper are adhered to each other by using a first pasting portion and a second pasting portion so as not to become detached from or misaligned with each other. In this configuration, the first pasting portion has a predetermined width and is arranged at a front or leading end in a carrying direction of the paper, while the second pasting portion is provided as a dot at both sides and aligned orthogonally to the carrying direction on the rear or trailing end side, with respect to the first pasting portion, in the carrying direction.

Nevertheless, in the printer apparatus described in Japanese Patent Application Laid Open Publication No. 2003-170640, a size of the sheet of paper is fixed because of limitations on a size of the paper cassette. Thus, the problem arises that a selected paper cannot be accommodated if a user of the printer apparatus desires to use paper having a different size, especially, a size greater than the paper cassette.

### SUMMARY OF THE INVENTION

A need has arisen for a printer apparatus cut sheet to solve the above-described problems. In particular, a need has arisen to provide a printer apparatus cut sheet formed, such that it may be contained in a paper cassette even if the cut sheets has a size greater than a size of the paper cassette.

To satisfy such needs, a printer apparatus cut sheets of the present invention is configured by superimposing a first sheet of paper and a second sheet of paper on each other. The cut sheet comprises a first pasting portion configured to secure the first sheet of paper and the second sheet of paper to each other and extending across a predetermined width on the side of a front or leading end in a carrying direction of the cut sheet, a second pasting portion configured to secure the first sheet of paper and the second sheet of paper to each other and comprising a plurality of dots of adhesive at both sides, aligned orthogonally to the carrying direction on a rear or trailing end side with respect to the first pasting portion, and a third pasting portion configured to secure the first sheet of paper and the second sheet of paper to each other comprising a plurality of dots of adhesive at the both edge ends on the rear end in the carrying direction with respect to the second pasting portion.

In another embodiment of the present invention, a printer apparatus cut sheet is configured by superimposing a first sheet of paper and a second sheet of paper on each other. The cut sheet comprises a second pasting portion configured to bond the first sheet of paper and the second sheet of paper to each other by a plurality of dots of adhesive at both sides, aligned orthogonally to a carrying direction on the rear end side of the cut sheet in the carrying direction; and a third pasting portion configured to bond the first sheet of paper and the second sheet of paper to each other by a plurality of dots of paste at the both sides on the rear end side with respect to the second pasting portion.

Further objects, features, and advantages of the present invention will be understood from the following detailed description of preferred embodiments of the present invention with reference to the accompanying figures.

### BRIEF DESCRIPTION OF THE DRAWINGS

Embodiments of the invention now are described with reference to the accompanying figures, which are given by way of example only, and are not intended to limit the invention.

FIG. 1 is an enlarged, cross-sectional view showing details of a paper separation section and a print mechanism section in a printer apparatus.

FIG. 2 is an enlarged, cross-sectional view of the print mechanism section.

FIG. 3 is another enlarged, cross-sectional view of the print mechanism section.

FIG. 4 is a plan view showing a cut sheet of paper related to a present embodiment in condition in which it is separated.

FIG. 5 is a perspective view showing the cut sheet of paper in condition in which it is unfolded.

FIG. 6 is a plan view showing a cut sheet of paper according to another embodiment in condition in which it is separated.

FIG. 7 is a plan view showing a cut sheet of paper of still another embodiment in condition which it is separated.

FIG. 8 is a plan view showing a cut sheet of paper of yet another embodiment in condition in which it is separated.

FIG. 9 is a plan view showing a cut sheet of paper of still yet another embodiment in condition in which it is separated.

FIG. 10 is a plan view showing the cut sheet of paper of the embodiment of FIG. 9 in condition in which it is unfolded.

FIG. 11 is a plan view showing a cut sheet of paper of a further embodiment in condition in which it is separated.

FIG. 12 is a plan view showing a cut sheet of still a further embodiment in condition in which it is separated.

FIG. 13 is a plan view showing a cut sheet of paper of yet a further embodiment in condition in which it is separated.

For a more complete understanding of the invention, the needs satisfied thereby, and the objects, features, and advantages thereof, reference now is made to the following description taken in connection with the accompanying drawings.

### DETAILED DESCRIPTION OF EMBODIMENTS OF THE INVENTION

Embodiments of the present invention now are described with reference to drawings. First, a printer apparatus 1 is described in which a printer apparatus cut sheet of the present invention is used.

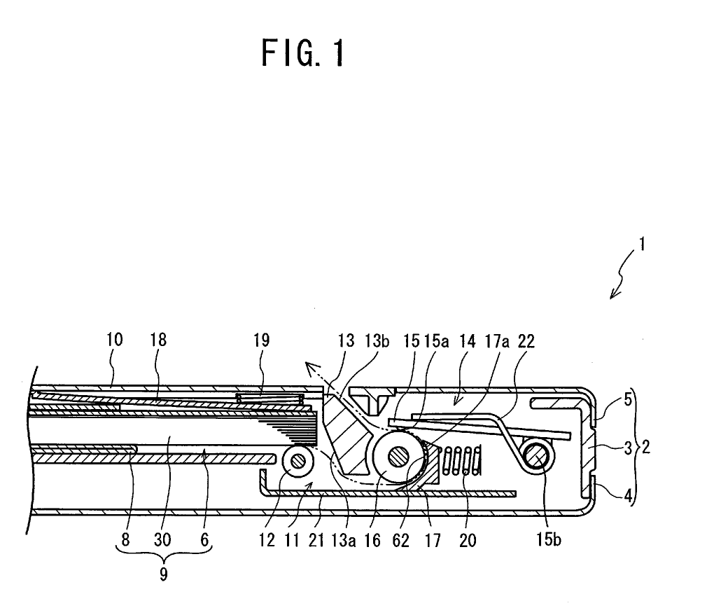

First, an outlined structure of printer apparatus 1 is described with reference to FIG. 1. Printer apparatus 1 has a relatively compact configuration with a planar and substantially rectangular shape having substantially an A6 size with a length of about 16 cm, a width of about 10 cm, and a thickness of about 2 cm. A body case 2 of printer apparatus 1 is comprised of a lower cover 4 that covers a bottom of a frame body 3 and an upper cover 5 that covers part of a top of frame body 3.

In a space of an upper side of frame body 3 excluding a space covered by upper cover 5, a paper housing 6 (i.e., a sheet feeding section) is defined. Paper housing 6 may house a paper package 9 which comprises a plurality of cut sheets of papers 30, for example, A6-A7 size, in a package material 8. An upper side of paper housing 6 is covered by a cap 10, which cap 10 is configured to swing or pivot. Body case 2 may comprise a lock mechanism (not shown) and thus may be locked by closing cap 10 in a condition in which paper package 9 is disposed in paper housing 6 as described above. A printer apparatus cut sheet of the present invention is disposed in paper package 9 as sheet of papers 30 and preferably is of the A6 size, when so disposed.

At an end on one side of paper housing 6, a pick-up roller 12, a separation block 13, and related components that constitute a paper separation section 11 are disposed. Further, a thermal head 15, a platen roller 16, and a paper guide 17, which constitute a print mechanism 14 described in detail below, are disposed beneath upper cover 5.

Paper separation section 11 is described as follows. At an end of paper housing 6 closer to print mechanism 14, pick-up roller 12 and separation block 13 are mounted. At an inner face of cap 10 facing paper housing 6, a pressure plate 18 is supported in a condition in which it may swing or pivot. A coil-shaped spring 19 is disposed between pressure plate 18 and cap 10 to apply a constant urging force to pressure plate 18 in such a direction as to swing or pivot pressure plate 18 downward.

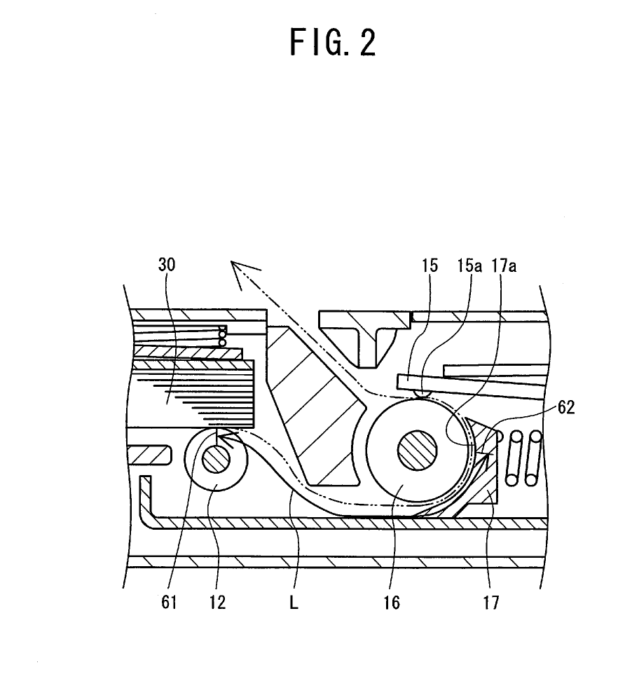

Paper package 9 is disposed in paper housing 6 in a condition in which a back surface of the lowermost one of sheet of papers 30, which are stacked with their printing surfaces facing downward, is exposed partially from package material 8. When cap 10 is closed to lock body case 2, pressure plate 18, urged downward by the above-described spring 19, presses the exposed portion of sheet of papers 30 via purchase material 18 toward pickup roller 12 to bring the back surface of sheet of papers 30 into contact with pickup roller 12. In this case, a position in which the back surface of sheet of papers 30 and pickup roller 12 come in contact with each other is supposed to be a roll-out position 61 (see FIG. 2) of pickup roller 12. Proximate to pickup roller 12, separation block 13 is mounted, which separation block 13 comprises a separation guide surface 13a inclined with respect to a paper feed direction of pickup roller 12.

In this configuration, when pickup roller 12 revolves for driving a dispatched sheet of paper, a carrying force is applied to the lowermost sheet of papers 30 in contact with pickup roller 12. Accordingly, by this force combined with a separating action applied by separation guide surface 13a of separation block 13, only the lowermost sheet of papers 30 is separated and dispatched.

Print mechanism 14 now is described. Adjacent to separation block 13, platen roller 16 is mounted in a revolvable manner, and paper guide 17 is disposed in proximity to the outer circumferential surface of platen roller 16. On paper guide 17, a concave, curve-shaped, sliding contact surface 17a is formed in such a manner that its section may be substantially, laterally-facing and U-shaped, along the outer peripheral surface of platen roller 16. Between paper guide 17 and body case 2, a pressure coil spring 20 is mounted, so that sliding contact surface 17a may be urged toward the outer circumferential surface of platen roller 16.

In this configuration, the dispatched sheet of papers 30 separated by the above-described paper separation section 11 is carried by pickup roller 12 and passes between a lower end of separation block 13 and a guide plate 21, which guides the dispatched sheet of papers 30 toward platen roller 16. As guided by guide plate 21, the dispatched sheet of papers 30 then is sent from the lower surface side of platen roller 16 to a position between platen roller 16 and paper guide 17. Subsequently, the dispatched sheet of papers 30 is carried in a reverse direction (i.e., in a laterally-facing and U-shaped direction) by rotary driving of platen roller 16 in a condition in which the dispatched sheet is held between the outer circumferential surface of platen roller 16 and sliding contact surface 17a of paper guide 17, until the sheet reaches the upper surface side of platen roller 16 in a condition in which its print surface faces upwards.

Thermal head 15 is disposed above platen roller 16 and comprises a heating element 15a, which constitute a printing section. Thermal head 15 is mounted, so that it may swing or pivot around a swing axis 15b, due to which heating element 15a may move into and out of contact with the upper surface of platen roller 16. Thermal head 15 thus is configured to swing or pivot freely, in order to prevent thermal head 15 from impeding an operation of removing one of sheet of papers 30 if the sheet becomes jammed between platen roller 16 and paper guide 17. Further, one end of a return, coil-type spring 22 is fixed to thermal head 15, so that heating element 15a of thermal head 15 is supplied constantly with a force urging spring 22 toward the upper surface of platen roller 16. In this configuration, heating element 15a of thermal head 15 comes in contact with the upper surface of sheet of paper 30 being carried by platen roller 16 in a condition in which the sheet's print surface faces upward as described above, so that printing is performed on sheet of paper 30 at a position at which thermal head 15 comes in contact with the sheet.

Thermal head 15, which may be of a line head-type thermal head, may be configured for printing each of a plurality of lines of an arbitrary character or image that extend orthogonally to a carrying direction of heat sensitive papers on sheet of paper 30 as it is carried through. A print width over which each line is printed is set substantially equal to a width of sheet of paper 30 for printing. With respect to the heat sensitive paper, a variety of types of paper may be used, such as a heat sensitive, coloring-type paper having a coloring layer that colors when heated by thermal head 15 or a heat sensitive, punch-type paper comprising a punch layer in which a hole is formed when heated, is stacked on a base material layer.

Separation block 13 has a sheet discharge guide surface 13b formed on it which is inclined with respect to a direction to which plate roller 16 feeds out the paper. In this configuration, after being printed upon by heating element 15a of thermal head 15, sheet of papers 30 is guided by sheet discharge guide surface 13b and discharged onto cap 10 through a gap between cap 10 and upper cover 5 of body case 2.

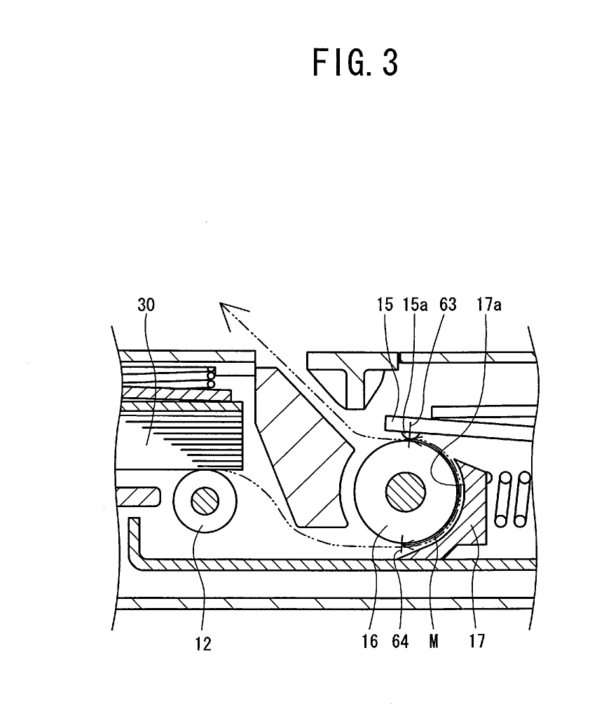

As shown in FIG. 2, a position at which sheet of paper 30 is gripped first between the outer circumferential surface of platen roller 16 and sliding contact surface 17a is identified to as a roller nip position 62. Further, a distance between roll-out position 61 of pickup roller 12 and roller nip position 62 is set to a distance L. Moreover, as shown in FIG. 3, a distance between a contact position 63 at which heating element 15a of thermal head 15 contacts with the sheet of paper 30 and a position 64 at which platen roller 16 first comes into come in contact with the sheet of papers 30, which is about half an outer circumferential length of platen roller 16, is set to distance M.

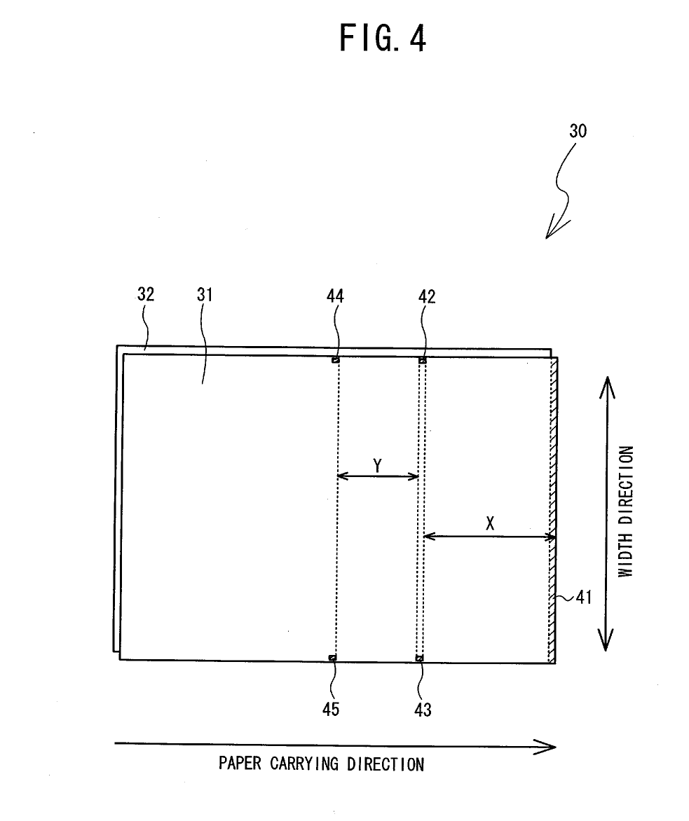

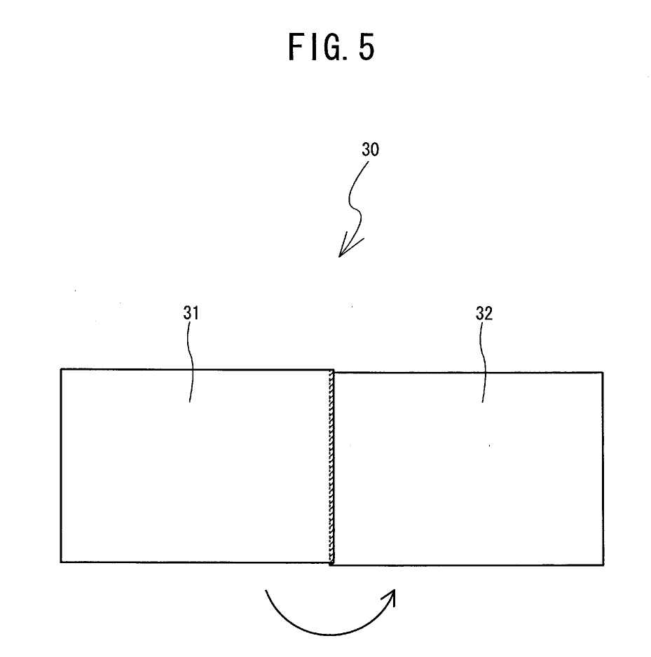

A structure of an embodiment of a printer apparatus cut sheet used as the sheet of paper 30 in printer apparatus 1 having the above-described configuration now is described with reference to FIGS. 4 and 5.

As shown in FIG. 4, sheet of paper 30 comprises a first cut sheet of paper 31 and a second cut sheet of paper 32. In an example shown in FIG. 4, sheet of paper 30 has an A7 size with a length in the carrying direction of 105 mm and a width of 74 mm. At the front or leading end of each of first sheet of paper 31 and of second sheet of paper 32 in their carrying direction, a first pasting portion 41 is provided in a width direction all the way across each sheet. Further, second pasting portions 42 and 43 at which the first sheet of paper 31 and second sheet of paper 32 are pasted to each other and which comprise a plurality of dots of adhesive are provided at two edges and are aligned orthogonally to the carrying direction toward the rear end side with respect to first pasting portion 41 in the carrying direction. Further, third pasting portions 44 and 45 at which first sheet of paper 31 and second sheet of paper 32 are pasted to each other and which comprise a plurality of dots of adhesive at two side edges toward the rear end with respect to second pasting portions 42 and 43 in the carrying direction are provided.

First pasting portion 41 is bonded with known adhesive agents that do not readily release their bond. Further, second pasting portions 42 and 43 and third pasting portions 44 and 45 are bonded with known adhesive agents that may release their bond, so that these portions may be separated (e.g., peeled off) after printing. First sheet of paper 31, which is of the heat sensitive type, has on its upper surface (i.e., the surfaces visible in FIGS. 4 and 5) a coloring layer that colors when heated or a punch layer that has a hole formed in it when heated, so that information is printed on it when heated by heating element 15a of thermal head 15 in printer apparatus 1.

After printing, sheet of papers 30 may be used as a sheet of paper greater in size than the A7 size by unfolding it, so that first and second sheets of paper 31 and 32 may lie symmetrically with respect to first pasting portion 41, as shown in FIG. 5. Although nothing may be printed by the printer apparatus 1 on both surfaces of second sheet of paper 32 or on a nonprinting surface of first sheet of paper 31 (i.e., surfaces not visible in FIGS. 4 and 5), a predetermined character or image may be printed beforehand on these surfaces. Therefore, sheet of papers 30 is used when it is desired to carry fixed words, characters, or images overflowing from an A7 size paper in addition to information to be printed by printer apparatus 1. For example, instructions and proscriptions are written beforehand on a traffic violation notification issued through clamp down on a traffic violation, a claim check issued when an agent of a financial institution has kept a passbook or the like from his customer, a gauge slip through check on an electricity or gas meter or the like, so that information concerning or identifying a violator or of the customer are printed on the printing surface by printer apparatus 1.

Further, if a distance in the paper carrying direction from first pasting portion 41 to second pasting portions 42 and 43 is a first distance X (arrow X in FIG. 4) and if a distance from second pasting portions 42 and 43 to third pasting portions 44 and 45 is a second distance Y (arrow Y in FIG. 4), the first distance X is equal to or greater than second distance Y (i.e., Y≦X). Moreover, first distance X is equal to or greater than distance L between roll-out position 61 of pickup roller 12 and nip position 62 of platen roller 16 (i.e., L≦X) See FIG. 2. In addition, second distance Y is equal or less than distance M between contact position 63 with heating element 15a and sliding start position 64 with platen roller 16 (i.e., Y≦M). See FIG. 3. In one example of sheet of paper 30, as shown in FIG. 4t, X=31.8 mm and Y=19.5 mm.

When sheet of papers 30 is being carried through printer apparatus 1, only pickup roller 12 remains in contact with sheet of papers 30 to convey a carrying force to it, until a front or leading end of sheet of papers 30 is nipped by the roller (e.g., platen roller 16) at the next stage of pickup roller 12. Pickup roller 12 remains in contact with only one (e.g., first sheet of paper 31) of the two sheets of paper to convey carrying force to it. Nevertheless, this carrying force also is conveyed to the other sheet of paper (e.g., second sheet of paper 32) through an action of second pasting portions 42 and 43 and third pasting portions 44 and 45, to carry the two sheets of paper securely and simultaneously, so that formation of wrinkles in the two sheets due to misalignment there between during carrying are reduced or eliminated.

Further, in sheet of papers 30 having this configuration, first distance X between first pasting portion 41 and second paring portions 42 and 43 is equal to or greater than distance L. See FIG. 2. Thus, when the front or leading end of sheet of papers 30 is gripped by platen roller 16 at nip position 62, second pasting portions 42 and 43 are not dispatched from roll-out position 61 of pickup roller. To the extent that any portions other than first pasting portion 41 is in contact with pickup roller 12, second pasting portions 42 and 43 are on the upstream side in the carrying direction of roll-out position 61, so that the carrying force of pickup roller 12 is conveyed from first sheet of paper 31 in contact with pickup roller 12 via the second pasting portions 42 and 43 to second sheet of paper 32. Therefore, even after first sheet of paper 31 is carried by pickup roller 12, second sheet of paper 32 is not left, so that the two sheets of paper may be carried smoothly.

Further, when second pasting portions 42 and 43 pass through roll-out position 61 of pickup roller 12, the front or leading end of the sheet of papers 30 already is nipped by platen roller 16, so that the carrying force of platen roller 16 also is conveyed to the two sheets of paper, thereby continuously carrying sheet of papers 30 smoothly.

Subsequently, when sheet of papers 30 is carried to the point at which information is printed thereon by heating element 15a of thermal head 15; owing to heat generated by printing, first sheet of paper 31 may adhere to the side of heating element 15a. Nevertheless, second sheet of paper 32 may adhere to the side of platen roller 16 that has carried second sheet of paper 32 from nip position 62. Thus, if, after printing, sheet of papers 30 is carried as it is, first sheet of paper 31 and second sheet of paper 32 may be separated (e.g., peeled off) readily from each other. In particular, as it goes far away from the front or leading end, it becomes more distant from first pasting portion 41 at which the two sheets of paper are adhered to each other across up to the entire width, so that they may be separated (e.g., peeled off) readily from each other. Nevertheless, because second distance Y is equal to or less than distance M between contact position 63 with heating element 15a and sliding start position 64 with platen roller 16 (see FIG. 3), when second pasting portions 42 and 43 pass through contact position 63, third pasting portions 44 and 45 already are gripped by platen roller 16. Therefore, even if the first sheet of paper 31 on which information is to be printed adheres to the side of thermal head 15, first sheet of paper 31 is bonded to the second sheet of paper 32 by third pasting portions 44 and 45, so that it is possible to prevent first sheet of paper 31 and second sheet of paper 32 from being separated (e.g., peeled off) from each other.

In such a manner, according to sheet of papers 30 of the present embodiment, the sheet of papers 30 may be fixed at both sides by second pasting portions 42 and 43 and third pasting portions 44 and 45, so that it is possible to prevent or to reduce the likelihood that first sheet of paper 31 and second sheet of paper 32 may be separated (e.g., peeled off) readily from each other when the sheet of paper is being carried. Further, because they are pasted to each other in a shape of dots by both second pasting portions 42 and 43 and third pasting portions 44 and 45, an amount of adhesive used at each of the portions may be reduced, so that after printing, first and second sheets of paper 31 and 32 are separated (e.g., peeled off) readily from each other, traces of the peeling are made less visible than in a configuration in which a pasting area is larger.

Further, it is preferable to form first sheet of paper 31 and second sheet of paper 32, so that they may have substantially equal thicknesses, for example, 55 μm. When sheet of papers 30 is carried by pickup roller 12, first sheet of paper 31 is on the side of pickup roller 12, and when sheet of paper is carried by platen roller 16, second sheet of paper 32 is on the side of platen roller 16. Therefore, if one of these sheets of paper has lower rigidity than the other, wrinkles may form readily in that sheet of paper when it is being carried by either of these rollers, so that first sheet of paper 31 and second sheet of paper 32 are separated (e.g., peeled off) readily from each other. Nevertheless, by providing such a configuration, no matter which one of these rollers may carry the sheet of paper, wrinkles are not easily formed in any one of the two sheets of paper, so that it is possible to prevent first and second sheets of paper 31 and 32 from being peeled off from each other.

In the present embodiment, first pasting portion 41 corresponds to “first pasting portion”, second pasting portions 42 and 43 correspond to “second pasting portion,” and third pasting portions 44 and 45 correspond to “third pasting portion.”

Printer apparatus cut sheets related to the present invention are not limited to the present embodiment, and its design may be changed variously as far as it does not depart from a scope of the described claims. For example, at the above-described “nip position” of platen roller 16, the top of the front end side of the sheet of papers 30 carried by pickup roller 12 is sandwiched between platen roller 16 and sliding contact surface 17a, so that sliding contact surface 17a presses sheet of papers 30 against the circumferential surface of platen roller 16. As a result, it refers to a position of the top of the front end of sheet of papers 30 at a moment when carrying force by platen roller 16 starts to act on sheet of papers 30. Therefore, besides the position shown in FIG. 1, nip position 62 may come toward the rear or trailing end side or the front end side in the carrying direction depending on a shape of sliding contact surface 17a of paper guide 17, so that a value of distance L changes correspondingly.

Further, a printer apparatus cut sheet related to the present invention may be applied not only to above-described printer apparatus 1, but also to a variety of types of printer apparatus as far as it does not depart from the range of the described claims. For example, such a printer apparatus cut sheet may include configuration in which paper guide 17 may be replaced with an appropriately driven roller which is urged toward platen roller 16, to nip sheet of papers 30 between the driven roller and platen roller 16. In this case, a position at which the drive roller and platen roller 16 come in contact with each other provides the “nip position.”

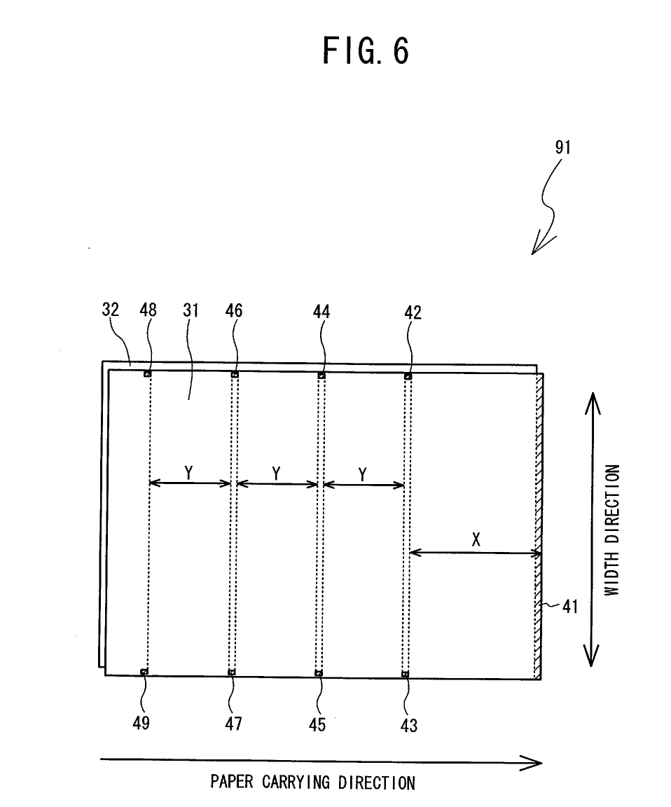

Further, the positions at which first sheet of paper 31 and second sheet of paper 32 are pasted to each other need not be limited to only first pasting portions 41, second pasting portions 42 and 43 and third pasting portions 44 and 45 of first sheet of paper 31 of the above-described embodiment. For example, paper printer apparatus cut sheets according to the embodiments depicted in FIGS. 6, 7, and 8 may be used.

In such a sheet of paper 91 according to an embodiment as depicted in FIG. 6, in addition to first pasting portion 41, second pasting portions 42 and 43, and third pasting portions 44 and 45, fourth pasting portions 46 and 47 are provided on the rear or trailing end rearward with respect to third pasting portions 44 and 45 by as much as second distance Y. Moreover, fifth pasting portions 48 and 49 are provided on the paper rear or trailing end rearward with respect to the fourth pasting portions 46 and 47 by as much as second distance Y. By this configuration, it is possible to prevent first sheet of paper 31 and second sheet of paper 32 from being separated (e.g., peeled off) from each other on the rear or trailing end side more than the configuration of sheet of papers 30 of the above-described embodiment. Fourth pasting portions 46 and 47 correspond to “fourth pasting portions,” and fifth pasting portions 48 and 49 correspond to “fifth pasting portions.”

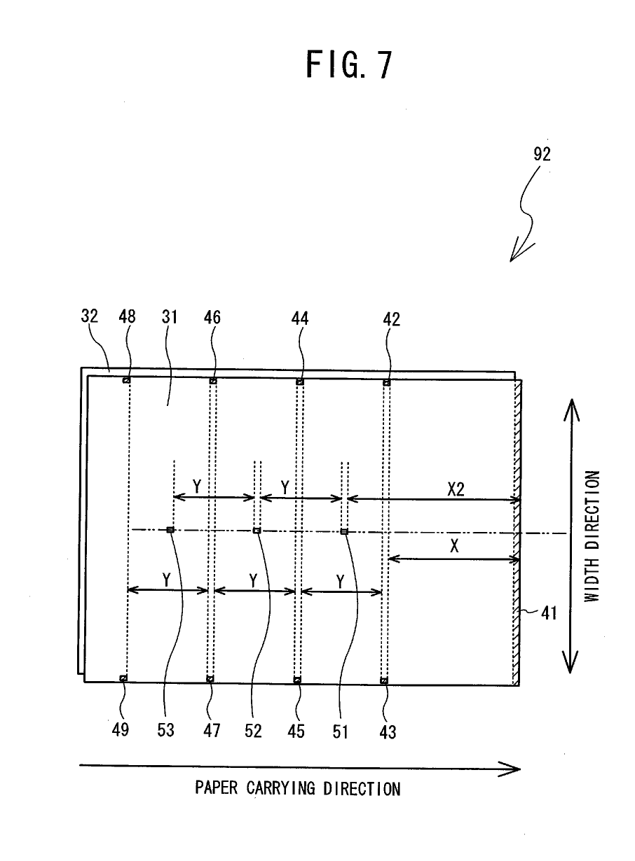

Further, in such a sheet of paper 92 according to another embodiment as depicted in FIG. 7, in addition to first pasting portion 41, second pasting portions 42 and 43, third pasting portions 44 and 45, fourth pasting portions 46 and 47, and fifth pasting portions 48 and 49 in the previous embodiment, first middle pasting portions 51, 52, and 53 are provided along a paper centerline. First middle pasting portion 51 is provided at a position that is distant from the paper carrying-directional front end by as much as distance X2 that is greater than first distance X and less than a sum of first distance X and second distance Y. The first middle pasting portion 52 is provided toward the paper carrying-directional rear end side with respect to the first middle pasting portion 51 by as much as second distance Y. Additionally, first middle pasting portion 53 is provided toward the paper carrying-directional rear end side with respect to first middle pasting portion 52 by as much as second distance Y. By this configuration, first sheet of paper 31 and second sheet of paper 32 are not separated (e.g., peeled off) from each other not only at both sides, but also along the centerline of sheet of paper 91. First middle pasting portions 51, 52, and 53 may correspond to “fourth pasting portions.”

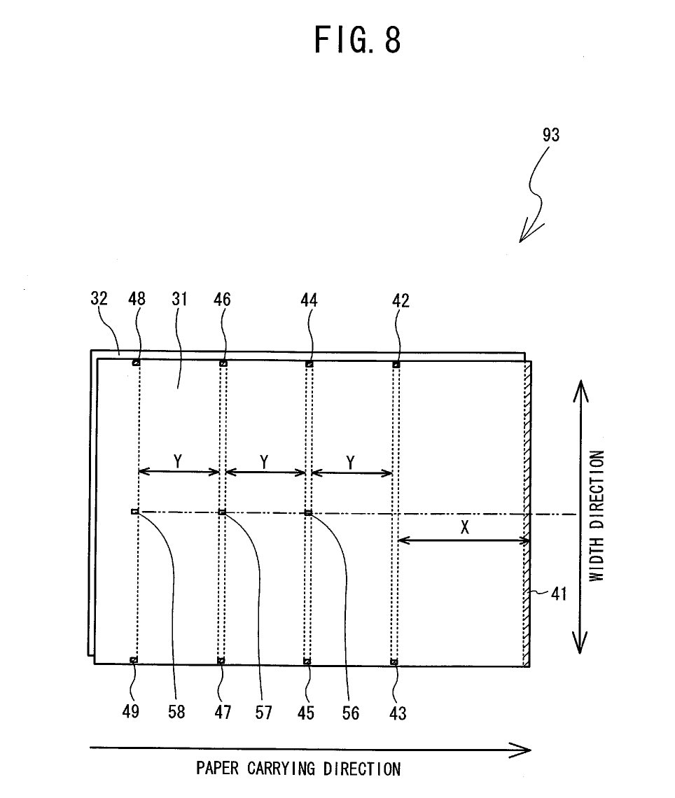

In such a sheet of paper 93, according to still another embodiment as depicted in FIG. 8, in addition to first pasting portion 41, second pasting portions 42 and 43, third pasting portions 44 and 45, fourth pasting portions 46 and 47, and fifth pasting portions 48 and 49 in first embodiment, second middle pasting portions 56, 57 and 58 are provided along a centerline. Second middle pasting portion 56 is provided at a position that is distant from the front or leading end by as much as first distance X. Further, second middle pasting portion 57 is provided toward the rear or trailing end with respect to second middle pasting portion 56 by as much as second distance Y. Additionally, second middle pasting portion 58 is provided toward the rear or trailing end side with respect to second middle pasting portion 57 by as much as second distance Y. By this configuration, first sheet of paper 31 and second sheet of paper 32 are not separated (e.g., peeled off) readily from each other, not only at both sides, but also at the centerline of sheet of paper 91. Second middle pasting portions 56, 57, and 58 correspond to “seventh pasting portions.”

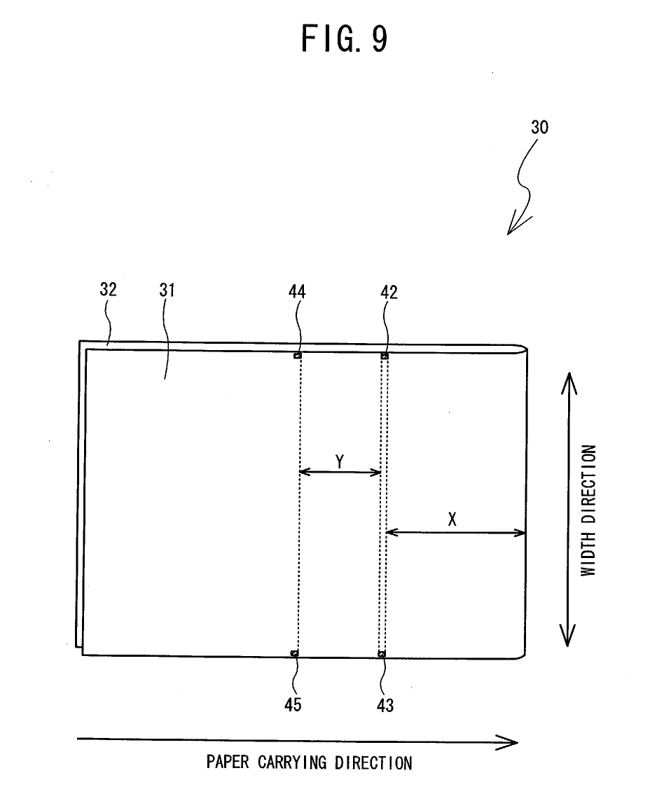

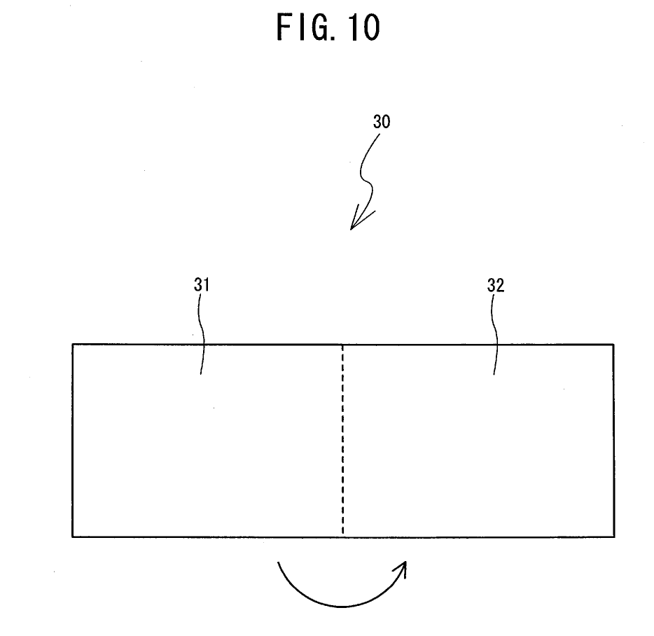

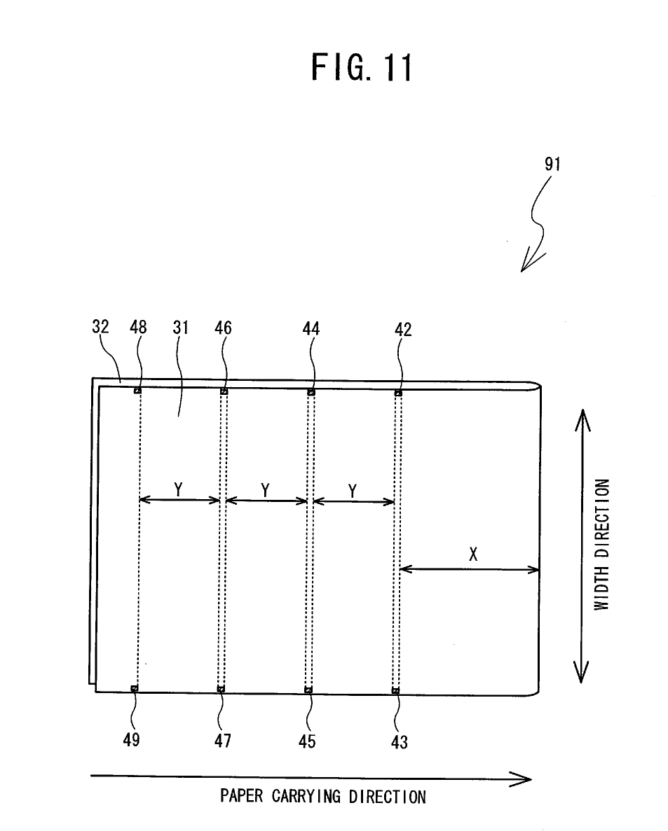

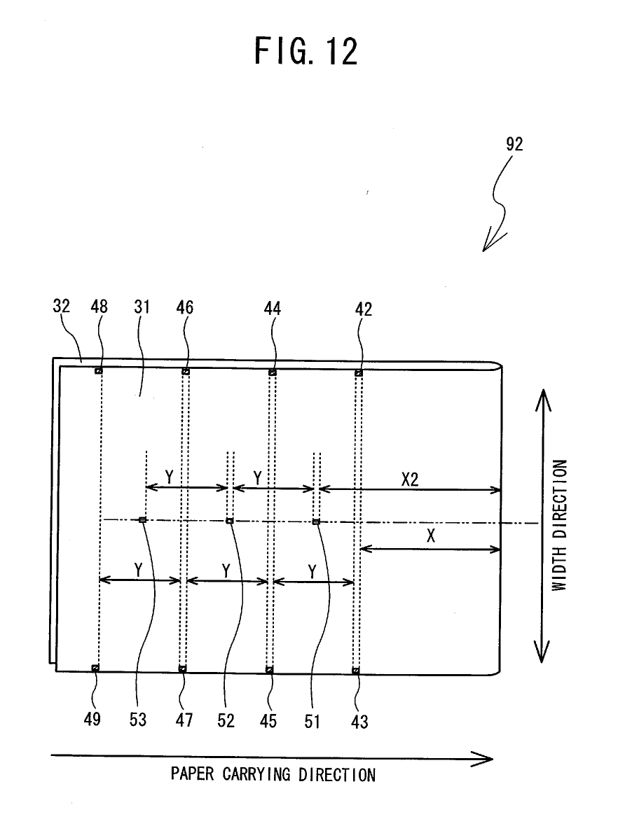

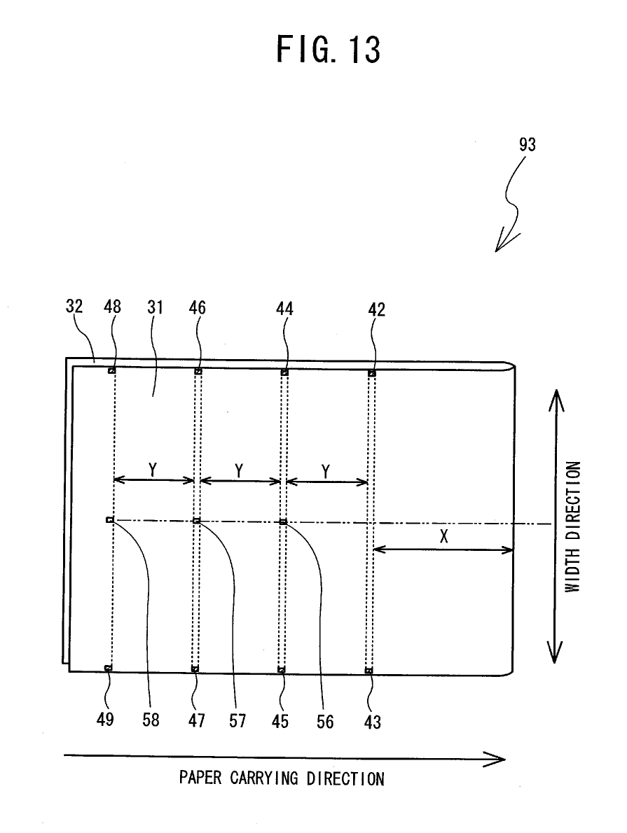

Although the above-described embodiments have configured first and second sheets of paper 31 and 32 by different sheets of paper, these two sheets may be formed by one sheet of paper. Specifically, like the embodiment depicted in FIG. 9, first and second sheets of paper 31 and 32 embodiment may be formed by one sheet of paper. A sheet of paper of this embodiment may be opened as depicted in FIG. 10. Thus, the risk that first and second sheets of paper 31 and 32 may be separated (e.g., peeled off) from the front or leading end of the sheet of paper when it is carried in a printer apparatus is reduced or eliminated. Similarly, like the embodiment depicted in FIG. 11, first and second sheets of paper 31 and 32 in the first embodiment may be formed by one sheet of paper. Similarly, like the embodiment depicted in FIG. 12, first and second sheets of paper 31 and 32 in the embodiment of FIG. 7 may be formed by one sheet of paper. Similarly, like the embodiment depicted in FIG. 13, first and second sheets of paper 31 and 32 in the embodiment of FIG. 8 may be formed by one sheet of paper. First sheet of paper 31 and second sheet of paper 32 need not have the same length.

Additionally, on first and second sheets of paper 31 and 32 of each of the embodiments formed by one sheet of paper as described above, first pasting portion 41 may be provided at an end on the side of a folding ridge as the front or leading end on the folding ridge side.

As described above, on a printer apparatus cut sheets of the present invention, a first pasting portion may adhere a first sheet of paper and a second sheet of paper by at least a portion of the width (e.g., a predetermined width) of the cut sheet at a front or leading end, a second pasting portion may paste the first and second sheets of paper by a plurality of dots of adhesive at both sides, aligned orthogonally to the carrying direction on the rear or trailing end side with respect to the first pasting portion. A third pasting portion may adhere the first and second sheets of paper by a plurality of dots of adhesive at both sides on the rear or trailing end side with respect to the second pasting portion. Thus, it is possible to eliminate the first sheet of paper and the second sheet of paper from being separated (e.g., peeled off) from each other when they are carried in a printer apparatus.

In the printer apparatus cut sheet of the present invention, in addition to the above-described effects of the present invention, the first sheet of paper and the second sheet of paper may have the same thickness. Thus, it is possible to reduce or eliminate the occurrence of a wrinkle or a bend in one of the two sheets of paper when they are carried in the printer apparatus.

In another printer apparatus cut sheet of the present invention, in addition to the above-described effects of the present invention, the first sheet of paper and the second sheet of paper are formed by one sheet of paper, and the first pasting portion is provided at a fold between the first sheet of paper and the second sheet of paper, so that it is possible to prevent the first sheet of paper and the second sheet of paper from being separated (e.g., peeled off) from each other. Because the fold is bonded by the first pasting portion, it is possible to reduce or eliminate swelling due to folding, thus preventing the sheet of paper from becoming jammed when it is being carried in the printer apparatus.

In a further printer apparatus cut sheets of the present invention, in addition to the above-described effects of the present invention, a fourth pasting portion may paste the first sheet of paper and the second sheet of paper by a plurality of dots of adhesive at substantially the centerline on the rear or trailing end side with respect to the third pasting portion. Thus, it is possible to eliminate or to reduce the likelihood that the first sheet of paper and the second sheet of paper may be misaligned with respect to each other and have wrinkles in them or being separated (e.g., peeled off) from each other on the more rear side. Further, the first sheet of paper and the second sheet of paper may be prevented from being misaligned from each other and having wrinkles in them or being separated (e.g., peeled off) from each other, not only at both sides orthogonal to the carrying direction, but also at the centerline.

In a still further printer apparatus cut sheet of the present invention, in addition to the above-described effects of the present invention, a fifth pasting portion may paste the first sheet of paper and the second sheet of paper by a plurality of dots of adhesive at both sides on the rear or trailing end side with respect to the third pasting portion. Thus, it is possible to prevent the first sheet of paper and the second sheet of paper from being misaligned from each other and having wrinkles in them or being separated (e.g., peeled off) from each other on the more rear side.

In another printer apparatus cut sheet of the present invention, in addition to the above-described effects of the present invention, if a distance between the front or leading end and the dot-shaped second pasting portions of the sheet of paper is X, a distance between the dot-shaped second pasting portions and the dot-shaped third pasting portions is Y, and a carrying distance from a roll-out position of a pickup roller in the printer apparatus to a nip position of a platen roller at which the sheet of paper rolled out from the pickup roller is gripped is L, it is possible to establish relationships of L≦X and Y≦X. Thus, it is possible to prevent the first sheet of paper and the second sheet of paper from being separated (e.g., peeled off) from each other even when the sheets of paper are carried along a circumferential surface of the pickup roller or the platen roller.

In still another printer apparatus cut sheet of the present invention, in addition to the above-described effects of the present invention, if half of the length of an outer circumference of a circle of a vertical section of the platen roller taken along its axis of revolution is M, it is possible to establish a relationship of Y≦M. Thus, it is possible to prevent the first sheet of paper and the second sheet of paper from being separated (e.g., peeled off) from each other even when the sheets of paper are carried along a circumferential surface of the platen roller.

In yet another printer apparatus cut sheet of the present invention, the second pasting portion may be provided on at least one of the first sheet of paper and the second sheet of paper to paste the first sheet of paper and the second sheet of paper by a plurality of dots of adhesive at both sides orthogonal to the carrying direction on the rear or trailing end side of the cut sheet, and the third pasting portion may paste the first sheet of paper and the second sheet of paper by a plurality of dots of adhesive at both sides on the rear or trailing end side with respect to the second pasting portion. Thus, it is possible to prevent the first sheet of paper and the second sheet of paper from being separated (e.g., peeled off) from each other when they are carried in the printer apparatus.

In still yet another printer apparatus cut sheet of the present invention, in addition to the above-described effects of the present invention, the first pasting portion may paste the first sheet of paper and the second sheet of paper by as much as a predetermined width on the front or leading end of the cut sheet, so that it is possible to prevent the first sheet of paper and the second sheet of paper from being separated (e.g., peeled off) from each other when they are carried in the printer apparatus.

In a further printer apparatus cut sheet of the present invention, in addition to the above-described effects of the present invention, the first sheet of paper and the second sheet of paper are formed by one sheet of paper, and an end on a fold provides a paper front or leading end, so that it is possible to prevent the first sheet of paper and the second sheet of paper, from being separated (e.g., peeled off) from the front or leading end and also to reduce or eliminate swelling due to folding, thus preventing the sheet of paper from becoming jammed when it is being carried.

In still a further printer apparatus cut sheet of the present invention, in addition to the above-described effects of the present invention, the first sheet of paper is provided at an end on a fold, so that the first sheet of paper and the second sheet of paper may be bonded by the first pasting portion. Therefore, it is possible to reduce or eliminate swelling due to folding, thus preventing the sheet of paper from becoming jammed when it is being carried.

As described above, a printer apparatus cut sheet of the present invention may be used effectively when it is desired to print information on a sheet of paper having this usable sheet of paper size or larger in a printer apparatus having a fixed size of a usable sheet of paper.

While the invention has been described in connection with various embodiments, it will be understood by those skilled in the art that variations and modifications of the embodiments described above may be made without departing from the scope of the invention. Though the various elements of the exemplary embodiments are shown in various combinations and configurations, which are exemplary, other combinations and configurations, including more, less, or only a single element, are also within the spirit and scope of the disclosure. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A printer apparatus cut sheet configured by superimposing a first sheet of paper and a second sheet of paper on each other, the cut sheet comprising:
a first pasting portion configured to bond the first sheet of paper and the second sheet of paper to each other and extending across a predetermined width on the side of a front end in a carrying direction of the cut sheet;
a second pasting portion configured to bond the first sheet of paper and the second sheet of paper to each other and comprising a plurality of dots of adhesive at both sides orthogonal to the carrying direction on a rear end with respect to the first pasting portion in the carrying direction; and
a third pasting portion configured to bond the first sheet of paper and the second sheet of paper to each other comprising a plurality of dots of adhesive at the both sides on the rear end side in the carrying direction with respect to the second pasting portion.

2. The printer apparatus cut sheet according to claim 1, wherein a first thickness of the first sheet of paper is equal to a second thickness of the second sheet of paper.

3. The printer apparatus cut sheets according to claim 1, wherein:
the first sheet of paper and the second sheet of paper are formed by one sheet of paper; and
the first pasting portion is provided at a fold between the first sheet of paper portion and the second sheet of paper portion.

4. The printer apparatus cut sheet according to claim 1, further comprising a fourth pasting portion configured to bond the first sheet of paper and the second sheet of paper by a plurality of dots of adhesive along substantially the centerline on the rear end side with respect to the third pasting portion.

5. The printer apparatus cut sheets according to claim 1, further comprising a fifth pasting portion configured to bond the first sheet of paper and the second sheet of paper to each other by a plurality of dots of adhesive at the both sides on the rear end side with respect to the third pasting portion.

6. The printer apparatus cut sheet according to claim 1, wherein if a distance between the front end and the dot-shaped second pasting portion of the sheet of paper is X, a distance between the dot-shaped second pasting portions and the dot-shaped third pasting portions is Y, and a carrying distance from a roll-out position of a pickup roller in a printer apparatus to a nip position of a platen roller from which the sheet of paper rolled out from this pickup roller is gripped is L, L≦X and Y≦X.

7. The printer apparatus cut sheet according to claim 6, wherein if half of a length of an outer circumference of a circle of a vertical section of the platen roller taken along its axis of revolution is M, Y≦M.

8. A printer apparatus cut sheet configured by superimposing a first sheet of paper and a second sheet of paper on each other, the cut sheet comprising:
a second pasting portion configured to bond the first sheet of paper and the second sheet of paper to each other by a plurality of dots of adhesive at both sides, aligned orthogonally to a carrying direction on the rear end side of the cut sheet; and
a third pasting portion configured to bond the first sheet of paper and the second sheet of paper to each other by a plurality of dots of adhesive at the both sides on the rear end side with respect to the second pasting portion.

9. The printer apparatus cut sheet according to claim 8, further comprising a first pasting portion configured to bond the first sheet of paper and the second sheet of paper to each other by at least a portion of width on the front end of the cut sheet.

10. The printer apparatus cut sheet according to claim 8, wherein:
the first sheet of paper and the second sheet of paper are formed by one sheet of paper; and
an end on the side of a fold forms the front end of the sheet of paper.

11. The printer apparatus cut sheet according to claim 9, wherein the first pasting portion is provided on the side of the fold.
